(19) United States
(12) Patent Application Publication
(10) Pub. No.: US 2017/0332621 A1
(43) Pub. Date: Nov. 23, 2017

(54) DECOY DEPLOYMENT AND WATER FOWL RETRIEVAL APPARATUS

(71) Applicants: Justin Ray Macias, Denham Springs, LA (US); Christopher Travis Thibodeaux, Denham Springs, LA (US)

(72) Inventors: Justin Ray Macias, Denham Springs, LA (US); Christopher Travis Thibodeaux, Denham Springs, LA (US)

(21) Appl. No.: 15/162,049

(22) Filed: May 23, 2016

(51) Int. Cl. A01M 31/06; A01M 99/00; G08C 17/02; H04N 7/18

(52) U.S. Cl. CPC A01M 31/06; H04N 7/188; A01M 99/00; G08C 17/02

(57) ABSTRACT

A decoy deployment and water fowl retrieval apparatus and method. The apparatus has a flotation frame configured with a motor providing propulsion and directional control to the frame. One or more water fowl decoys may be attached to the frame. The flotation frame has a forwardly facing opening and a net disposed to scoop a downed waterfowl into the scoop. The apparatus is controlled by a radio frequency remote controller. The apparatus may tow one or more decoys in a decoy display to a desired position. The apparatus may also be operated as a decoy to simulate water fowl swimming on a body of water.

### BACKGROUND OF THE INVENTION

The present invention relates to apparatus for water fowl observation and hunting, and more particularly to an apparatus for the deployment, positioning, and retrieval of decoys and retrieval of such water fowl.

Currently, there are many decoy apparatus for attracting water fowl, such as ducks, geese, and swans. It is desirable to attract water fowl to a person's location for observation, such as bird watching or scientific research, and in other circumstances, for hunting. Decoys available in the art are typically stationary or uncontrolled. Often, multiple decoys are tethered together so as to avoid being dispersed by surface winds or water currents. The inventor has found that it is desirable to attract live ducks with movement of the decoys in order to present a more natural display.

In the hunting context, the successful sportsman will also have a need to retrieve any downed birds that they may have shot during an outing. Many sportsmen will have specially trained hunting dogs to retrieve their downed ducks. In some circumstances the dogs may be unable to locate the downed duck and may not have a level of training sufficient to respond to their owner's directional commands to locate and retrieve the downed duck. In these cases, the duck may be lost to the hunter before he is able to retrieve the downed duck.

As can be seen, there is a need for an apparatus that provides for movement of a decoy, or decoy display and may also provide an apparatus for the retrieval of a downed water fowl, such as a duck.

### SUMMARY OF THE INVENTION

In one aspect of the present invention, a decoy apparatus includes: a flotation frame; one or more water fowl decoys attached to the flotation frame; a motor coupled to the flotation frame; a propeller operable by the motor to propel the decoy apparatus; and a control circuitry operatively connected to motor and configured to receive a control signal for controlling the motor. The flotation frame may include an aft transom portion; and a plurality of flotation arms forwardly extending from the transom portion. The flotation arms may be generally parallel with a longitudinal axis of the decoy apparatus.

In some embodiments, a net may be attached to the flotation frame having a forward end suspended from the flotation arms. In other embodiments, a forward end of the net is suspended below a bottom surface of the flotation arms and an aft end of the net is suspended beneath the flotation frame forming a forwardly opening scoop.

In other aspects of the invention, the decoy apparatus also includes a remote control transmitter configured to communicate with a receiver connected to the control circuitry. The decoy apparatus of claim 1, wherein the one or more water fowl decoys is a duck decoy or a goose decoy. The decoy apparatus may also be equipped with a camera operatively connected to the control circuitry.

Additional aspects of the invention include a method of retrieving a downed water fowl. The method includes the steps of providing a retrieval apparatus having a flotation frame with an aft transom portion, a plurality of flotation arms forwardly extending from the transom portion and defining a forwardly oriented opening between the flotation arms; a net suspended between the flotation arms and the transom portion, defining a forwardly oriented scoop; one or more water fowl decoys attached to the flotation frame; a motor coupled to the flotation frame; a propeller operable by the motor to propel the decoy apparatus; and control circuitry operatively connected to motor and a radio frequency receiver configured to receive a control signal for controlling the motor; and providing a radio frequency transmitter configured to communicate the control signal to the radio frequency receiver. The method may also include deploying the retrieval apparatus in a body of water containing a downed water fowl. Other steps of the method may include operating one or more controls on the radio frequency transmitter to maneuver the retrieval apparatus to the downed water fowl. The method operating the one or more controls to scoop the downed water fowl into the net. Additionally, the method may include operating the one or more controls to maneuver the retrieval apparatus carrying the downed water fowl to a desired location.

These and other features, aspects and advantages of the present invention will become better understood with reference to the following drawings, description and claims.

### BRIEF DESCRIPTION OF THE DRAWINGS

FIG. 1 is a perspective view of an embodiment of a decoy deployment and retrieval apparatus, shown in use.

FIG. 2 is a rear perspective view of the decoy deployment and retrieval apparatus.

FIG. 3 is an exploded view of the decoy deployment and retrieval apparatus.

FIG. 4 is a section view of the apparatus, taken along line 4-4 in FIG. 1, with motor 26 simplified for clarity.

FIG. 5 is a detail section view of the decoy deployment and retrieval apparatus.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a decoy deployment apparatus that may deploy, position, and redeploy a decoy display including a plurality of decoy bodies. The apparatus may also be utilized for the retrieval of downed water fowl, such as during a hunting event.

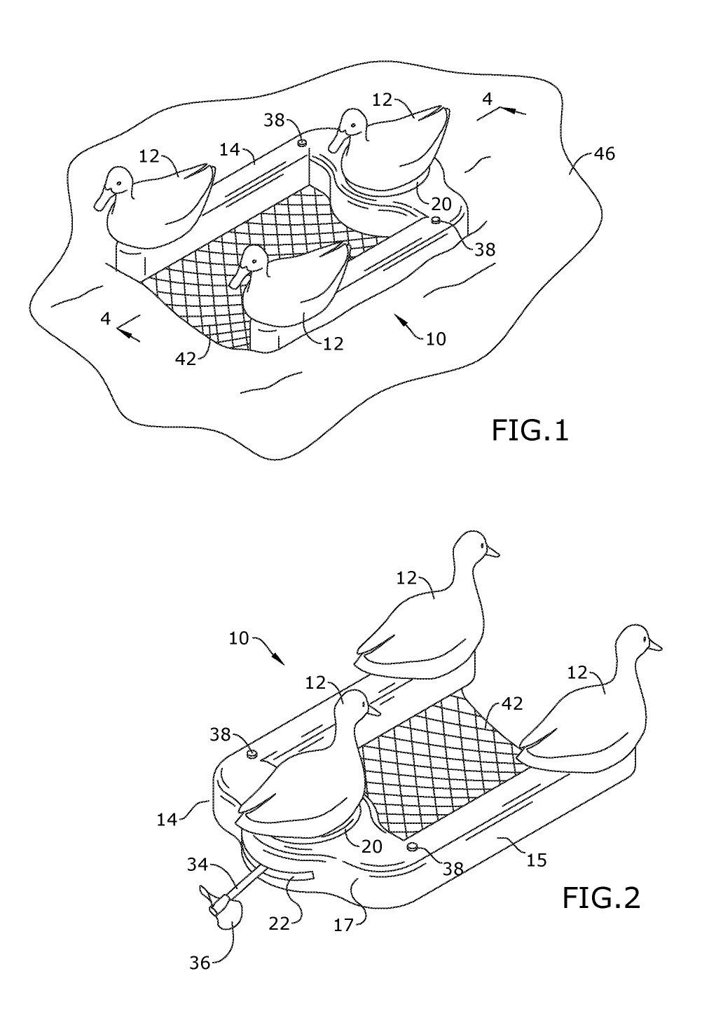

As best seen in reference to FIG. 1, an embodiment of a decoy deployment and retrieval apparatus 10 is illustrated. The apparatus 10 may include one or more decoys 12 attached to a flotation frame 14. The flotation frame 14 is adapted for flotation on a body of water 46, such as a pond, lake, river, or stream.

The flotation frame 14 is provided with a pair of elongate flotation arms 15, or pontoons extending forwardly from an aft transom portion 17. The elongate flotation arms 15 are generally aligned in parallel along a longitudinal axis of the apparatus 10. The one or more decoys 12 may be attached at various points of the flotation frame 14. By way of non-limiting example, one decoy 12 may be attached to each pontoon 15 and another positioned on the transom portion 17. The decoys 12 may be attached to be arranged in a formation utilized by a live duck that they are intended to attract.

A retrieval net 42 may be suspended between the flotation arms 15. The retrieval net 42 and may be secured to the flotation arms 15 via an attachment point 38, which may include a fastener, such as a pin, hook, screw, adhesive, or the like. A forward end of the net 42 is disposed across a forward opening defined between the flotation arms 15 and is suspended so that at least the forward end of the net 42 may be suspended beneath the surface of the body of water 46.

As seen in reference to FIG. 2, a propeller shaft slot 22 is defined across an aft portion of the transom portion 17 and is adapted to receive a propeller shaft 34 there through. The propeller shaft 34 is operatively connected to a propeller 36 at an aft end of the shaft 34 and a motor 26 mounted to the transom portion 17. The propeller shaft 34 is operable by the motor 26 so as to rotate the propeller 36 to maneuver the apparatus 10 through the body of water 46.

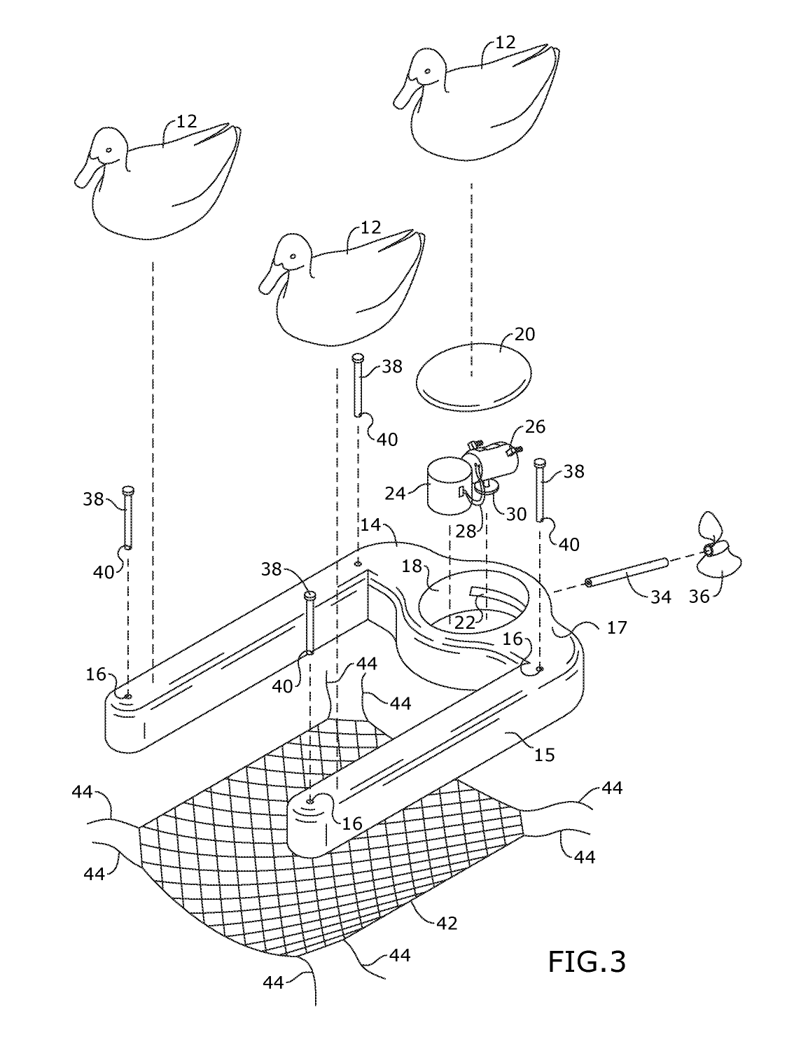

As seen in reference to FIG. 3, the transom portion may include a compartment 18, having a protective cover 20, where the compartment 18 adapted to receive a battery 24 to provide electrical power to a motor 26 and associated control circuitry and wiring 28 for controlling the motor 26 and other features of the apparatus 10. A motor mount 30 connects the motor 26 to the transom 17 within the compartment 18. In the embodiment shown, the motor mount 30 pivotally connects the motor to the transom 17 such that the drive and directional control of the apparatus 10 is controlled by rotation of the motor 26 about the mount 30.

The net 42 may be provided with a plurality of ties 44 at one or more corner portions. The pins 38 may be received through a plurality of pin apertures 16 defined through the flotation arms 15 at the forward end of the apparatus 10 and through the flotation arms 15 or transom 17 towards the aft end of the apparatus 10. A tie off hole 40 may be defined at a bottom end portion of the pins 38 and are adapted to receive the ties 44 to secure the net to the apparatus 10.

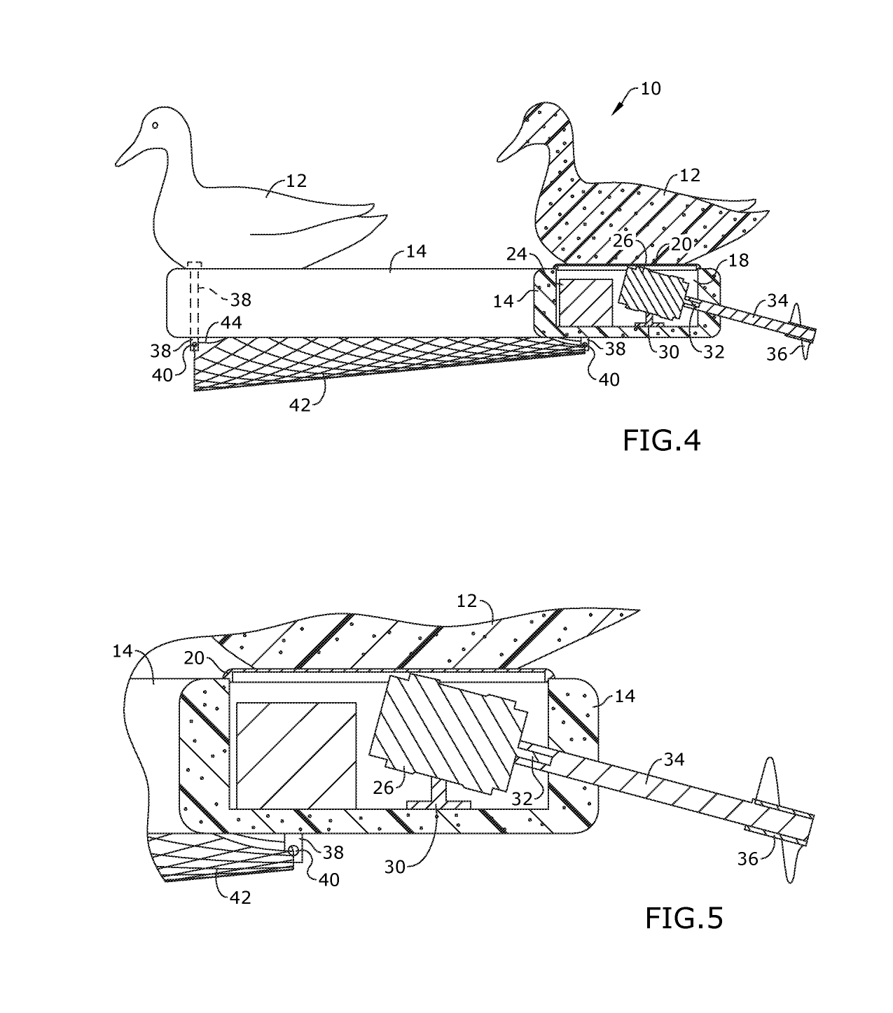

As seen in reference to FIG. 4, the forward end of the net 42 is attached to the apparatus 10 such that it may extend below the surface of the body of water 46, while the aft end may be retained closer to the flotation body 14. By this arrangement, the net 42 may form a scoop for the retrieval of a downed water fowl, such as a duck, or one of the decoys in a display of tethered decoys.

As further seen in reference to FIGS. 4, and 5, an operative arrangement of and embodiment of the motor 26, propeller shaft 34 and propeller 36 are shown. With this configuration, the propeller 36 is disposed so as to operate beneath the surface of the body of water 46 so as to avoid entanglement with vegetation and the like that are frequently encountered in and around the body of water 46. Alternatively, the motor 26 may be positioned in a fixed position relative to the flotation body 14 and directional control may be provided via rudder (not shown).

As previously indicated, the motor 26 is pivotally mounted to the mount 30, such that it may traverse from side to side to provide directional control for the apparatus 10. The control circuitry 28 may include a radio frequency receiver for the reception of one or more of a directional or a speed control signal to control the apparatus 10. The control signals may be provided by a remote control radio frequency transmitter that may be utilized by the user so as to control the movement of the apparatus 10 on the body of water 46, such as a conventional radio controlled (RC) vehicle controller.

For bird watchers, the apparatus 10 may also be fitted with a camera to facilitate photographing of any water fowl that may be attracted by the decoys 12. The apparatus 10 may also be configured with hook that is operable to grasp a decoy or a cord interconnecting a string of decoys. The camera and hook may be operably controlled by the control circuitry 28.

In operation, the user may configure the decoys 12 to the flotation frame 14. The apparatus 10 may be placed within the body of water 46 and controlled via the remote control transmitter to mimic the movement of live water fowl on the body of water in order to attract the water fowl to the user's location.

The apparatus 10 may also be utilized to maneuver decoys or a string of decoys on the body of water. In this case, a lead decoy on the string may be positioned within the opening between the flotation arms 15. The apparatus may be maneuvered via the remote control to tow the decoys to a desired location on the body of water. The apparatus 10 may then reverse course so as to remove the lead decoy from between flotation arms 15. With the string of decoys in a relatively fixed position, the apparatus 10 and mounted decoys 12 may be maneuvered to “swim” around the decoy display to provide added realism and attract more water fowl.

In the event that the apparatus 10 is utilized as a hunting aid to retrieve downed water fowl. The operator can maneuver the apparatus 10 towards the downed water fowl, scoop it up with the net 42 and retrieve the downed water fowl from the body of water.

It should be understood, of course, that the foregoing relates to exemplary embodiments of the invention and that modifications may be made without departing from the spirit and scope of the invention as set forth in the following claims.

What is claimed is:

1. A decoy apparatus comprising:
a flotation frame;
one or more water fowl decoys attached to the flotation frame;
a motor coupled to the flotation frame;
a propeller operable by the motor to propel the decoy apparatus; and
a control circuitry operatively connected to motor and configured to receive a control signal for controlling the motor.

2. The decoy apparatus of claim 1, wherein the flotation frame comprises:
an aft transom portion; and
a plurality of flotation arms forwardly extending from the transom portion.

3. The decoy apparatus of claim 2, wherein the flotation arms are generally parallel with a longitudinal axis of the decoy apparatus.

4. The decoy apparatus of claim 2, further comprising:
a net attached to the flotation frame having a forward end suspended from the flotation arms.

5. The decoy apparatus of claim 4, wherein the net is attached with a forward end of the net suspended below a bottom surface of the flotation arms.

6. The decoy apparatus of claim 5, wherein an aft end of the net is suspended beneath the flotation frame forming a forwardly opening scoop.

7. The decoy apparatus of claim 6, further comprising:
a remote control transmitter configured to communicate with a receiver connected to the control circuitry.

9. The decoy apparatus of claim 1, wherein the one or more water fowl decoys is a duck decoy.

10. The decoy apparatus of claim 1, wherein the one or more water fowl decoys is a goose decoy.

11. The decoy apparatus of claim 1, further comprising:
a camera operatively connected to the control circuitry.

12. A method of retrieving a downed water fowl, comprising:
providing a retrieval apparatus having:
a flotation frame having an aft transom portion, and a plurality of flotation arms forwardly extending from the transom portion and defining a forwardly oriented opening between the flotation arms;
a net suspended between the flotation arms and the transom portion, defining a forwardly oriented scoop;
one or more water fowl decoys attached to the flotation frame;
a motor coupled to the flotation frame;
a propeller operable by the motor to propel the decoy apparatus; and
a control circuitry operatively connected to motor and a radio frequency receiver configured to receive a control signal for controlling the motor; and
providing a radio frequency transmitter configured to communicate the control signal to the radio frequency receiver.

13. The method of claim 12, further comprising:
deploying the retrieval apparatus in a body of water containing a downed water fowl.

14. The method of claim 13, further comprising:
operating one or more controls on the radio frequency transmitter to maneuver the retrieval apparatus to the downed water fowl.

15. The method of claim 14, further comprising:
operating the one or more controls to scoop the downed water fowl into the net.

16. The method of claim 15, further comprising:
operating the one or more controls to maneuver the retrieval apparatus carrying the downed water fowl to a desired location.
